(19) United States
(12) Patent Application Publication
(10) Pub. No.: US 2025/0327286 A1
(43) Pub. Date: Oct. 23, 2025

(54) DIRECT SINK FILTRATION DEVICE, SYSTEM, AND METHOD

(71) Applicant: SCHIER PRODUCTS COMPANY, Shawnee, KS (US)

(72) Inventors: Grahm HEIDE, Shawnee, KS (US); Cameron SINCLAIR, Shawnee, KS (US); Clark BUSENITZ, Shawnee, KS (US); Barry GILMAN, Shawnee, KS (US); Cole FINCHAM, Shawnee, KS (US); Luke ISMERT, Shawnee, KS (US); Tad ASAY, Shawnee, KS (US); Benjamin BROWN, Shawnee, KS (US)

(21) Appl. No.: 19/182,431

(22) Filed: Apr. 17, 2025

Related U.S. Application Data
(60) Provisional application No. 63/635,153, filed on Apr. 17, 2024.

(51) Int. Cl. E03C 1/264; B01D 35/02; C02F 1/00; C02F 101/32

(52) U.S. Cl. CPC E03C 1/264; B01D 35/02; C02F 1/003; C02F 2101/32

(57) ABSTRACT

A filtration device for coupling to a drain hole of a sink and to a drainpipe includes a basin, a cartridge outlet tube, an outlet housing, and a collector. The basin has an inlet and an outlet. The cartridge outlet tube extends from the outlet of the basin and has a tube inlet at an upper end thereof. The outlet housing defines a channel fluidly connecting an outer volume of the basin to the tube inlet. The housing channel has an inlet located below the tube inlet. The collector defines a collector chamber in the basin chamber and has a bottom wall located above the housing channel inlet. The collector defines a collector channel fluidly connecting the outer volume to the collector chamber with a collector outlet located above the collector bottom wall.

### CROSS-REFERENCE TO RELATED APPLICATIONS

The present application claims the priority benefit of earlier-filed U.S. Provisional Application Ser. No. 63/635,153, filed Apr. 17, 2024, entitled DIRECT SINK FILTRATION DEVICE, SYSTEM, AND METHOD, which is incorporated by reference in its entirety herein.

### BACKGROUND

Commercial grease traps are often located in buried, underground tanks and are fluidly connected to inaccessible plumbing. As a result, installation and cleaning of grease traps requires professional labor with specialized tools. These services are cost prohibitive for residential uses, so residential plumbing remains vulnerable to grease issues. Additionally, various other solids can cause build up, clogs, and other issues in grease traps and connected plumbing.

Thus, there is a need for improved means and methods of filtering grease and solids from wastewater. This background discussion is intended to provide information related to the present invention which is not necessarily prior art.

### SUMMARY

Embodiments of the current invention address one or more of the above-mentioned problems and provide a distinct advance in the art of devices and methods of filtering grease and solids from wastewater.

One embodiment of the invention is a device for coupling to a drain hole of a sink and to a drainpipe. The device includes a basin, a cartridge outlet tube, an outlet housing, and a collector. The basin defines a basin chamber, a basin inlet through which fluid from the drain hole can flow into the basin chamber, and a basin outlet through which the fluid can exit the basin chamber. The cartridge outlet tube is positioned in the basin chamber and has a lower end defining a tube outlet through which the fluid can flow through the basin outlet and an upper end defining a tube inlet. The outlet housing defines a housing channel fluidly connecting an outer volume of the basin chamber to the tube inlet. The housing channel has a housing channel inlet located below the tube inlet.

The collector defines a collector chamber in the basin chamber and has a collector bottom wall located above the housing channel inlet. The collector defines a collector channel fluidly connecting the outer volume to the collector chamber. The collector channel has a collector channel outlet through which fluid flows into the collector chamber from the outer volume. The collector channel outlet is located above the collector bottom wall.

A device according to another embodiment of the invention comprises a basin and a collector. The basin defines a basin chamber, a basin inlet through which fluid from the drain hole can flow into the basin chamber, and a basin outlet through which the fluid exits the basin chamber. The collector is sized to fit through the drain hole and is operable to be removably positioned in the basin chamber. The collector defines a collector chamber in the basin chamber and has a collector bottom wall located at a distance relative to the basin bottom wall when positioned in the basin chamber. The collector defines a collector channel connecting a lower volume of the basin chamber to the collector chamber. The collector channel has a collector channel outlet through which fluid flows into the collector chamber from the lower volume. The collector channel outlet is positioned above the collector bottom wall.

Another embodiment of the invention is a method of installing a sink filtration device to a drain hole of a sink and to a drainpipe. The method includes positioning a basin gasket on a top surface of the sink around the drain hole; and inserting a basin into the drain hole so that a basin flange of the basin is positioned on the basin gasket. The basin has a basin side wall and a basin bottom wall that together define a basin chamber. The method further includes positioning an insert gasket on a top surface of the basin bottom wall around a basin outlet defined by the basin bottom wall; inserting a tubular threaded insert through the basin outlet so that an insert flange of the tubular threaded insert is positioned on the insert gasket; positioning a basin sleeve against a bottom surface of the sink around the drain hole so that a sleeve gasket seated on a sleeve flange of the basin sleeve contacts the bottom surface of the sink and so that the basin sleeve receives the basin and a sleeve aperture at a bottom end of the basin sleeve receives at least a portion of the tubular threaded insert; fastening a basin nut to the tubular threaded insert so that the basin nut applies a downward force on the basin via the insert flange and an upward force on a bottom surface of the basin sleeve, thereby clamping the basin and the basin sleeve to the sink; and inserting a cartridge assembly through the drain hole so that the cartridge assembly is removably positioned inside the basin to define with the basin side wall an outer volume of the basin chamber.

The cartridge assembly includes a cartridge outlet tube, an outlet housing, and a collector. The cartridge outlet tube has a lower end and an upper end. The lower end extends into the tubular threaded insert when the cartridge assembly is in the basin and defines a tube outlet in fluid communication with the tubular threaded insert. The upper end defines a tube inlet. The outlet housing defines a housing channel connecting the outer volume to the tube inlet when the cartridge assembly is positioned in the basin. The housing channel has a housing channel inlet positioned below the tube inlet. The collector defines a collector chamber and has a collector bottom wall positioned above the housing channel inlet. The collector defines a collector channel connecting the outer volume to the collector chamber when the cartridge assembly is positioned in the basin. The collector channel has a collector channel outlet through which fluid flows into the collector chamber from the outer volume when the cartridge assembly is positioned in the basin. The collector channel outlet is located above the collector bottom wall.

A device according to another embodiment of the invention comprises a basin assembly and a cartridge assembly. The basin assembly is for coupling to the sink at the drain hole and includes a basin side wall and a basin bottom wall. The basin side wall defines a basin inlet for receiving fluid flowing from the drain hole. The basin bottom wall is connected to the basin side wall to define a basin chamber. The basin bottom wall defines a basin outlet through which fluid can flow to the drainpipe.

The cartridge assembly is sized to fit through the drain hole and removably couple with the basin assembly inside the basin chamber to define an outer volume of the basin chamber with the basin side wall. The cartridge assembly includes a cartridge outlet tube, an outlet housing, and a collector. The cartridge outlet tube has a lower end and an upper end. The lower end extends into the basin outlet and defines a tube outlet in fluid communication with the basin outlet. The upper end defines a tube inlet at a first distance relative to the basin bottom wall when the cartridge assembly is positioned in the basin chamber. The outlet housing defines a housing channel connecting the outer volume to the tube inlet. The housing channel has an inlet at a second distance relative to the basin bottom wall when the cartridge assembly is positioned in the basin chamber. The second distance is shorter than the first distance. The collector defines a collector chamber in the basin chamber and has a collector bottom wall at a third distance relative to the basin bottom wall when the cartridge assembly is positioned in the basin chamber. The third distance is longer than the second distance. The collector defines a collector channel connecting the outer volume to the collector chamber. The collector channel has a collector channel outlet through which fluid flows into the collector chamber from the outer volume. The collector channel outlet is located at a fourth distance relative to the basin bottom wall when the cartridge assembly is positioned in the basin chamber. The fourth distance is longer than the third distance.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF DRA WINGS

Embodiments of the current invention are described in detail below with reference to the attached drawing figures, wherein:

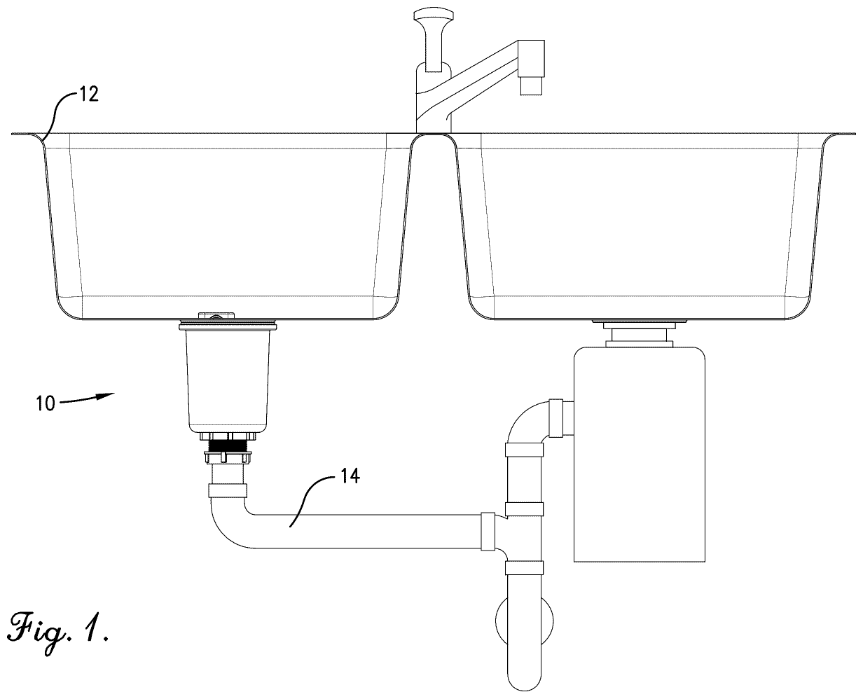

FIG. 1 is a perspective view of a sink filtration device constructed according to an embodiment of the present invention and installed on an exemplary sink;

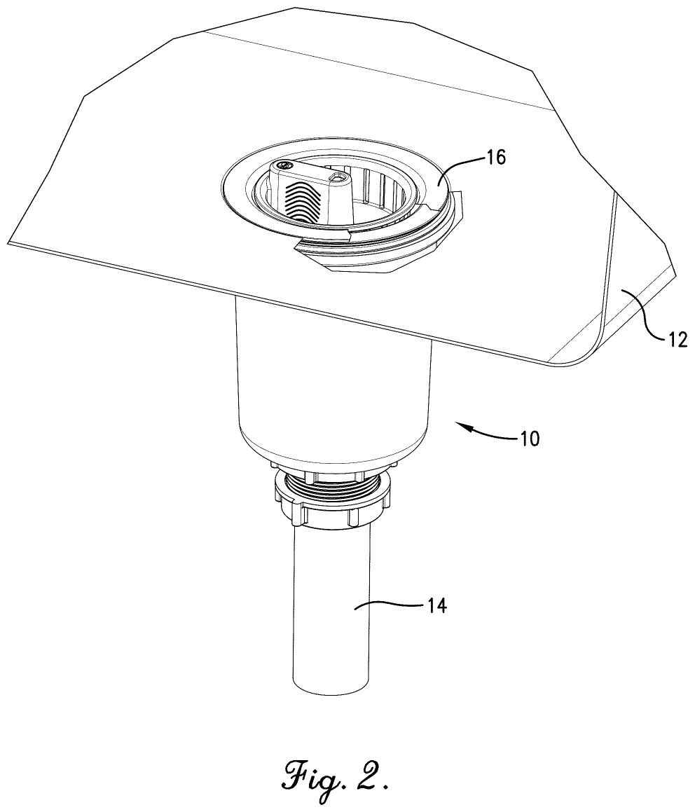

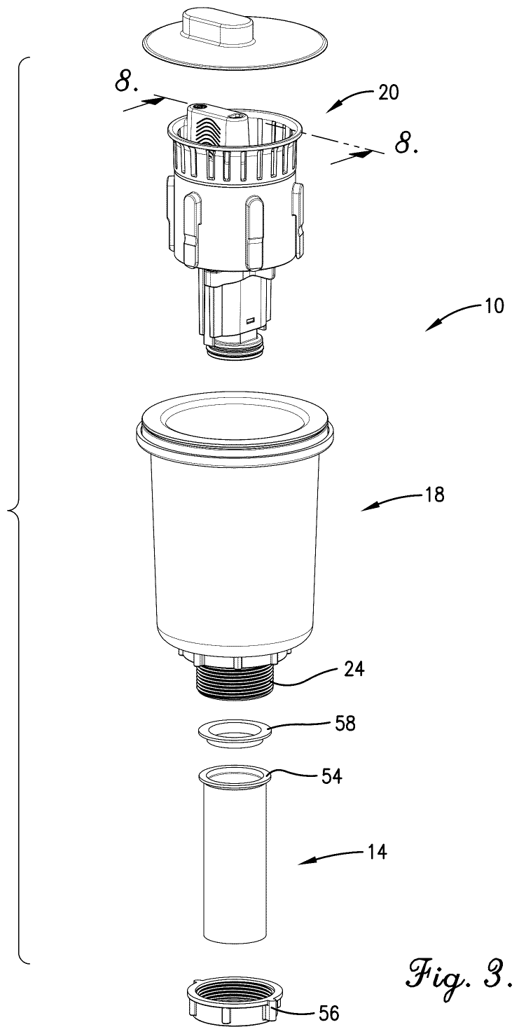

FIG. 2 is a perspective view of the device of FIG. 1 coupled to a drain hole of the sink;

FIG. 3 is an exploded view of the device of FIG. 1;

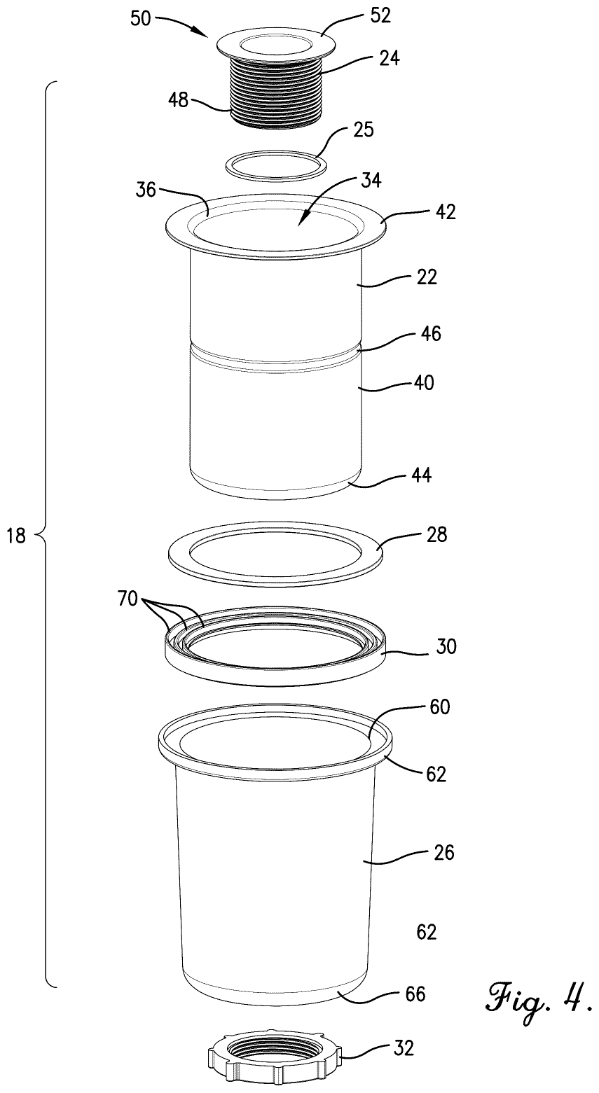

FIG. 4 an exploded view of a basin assembly of the device of FIG. 1;

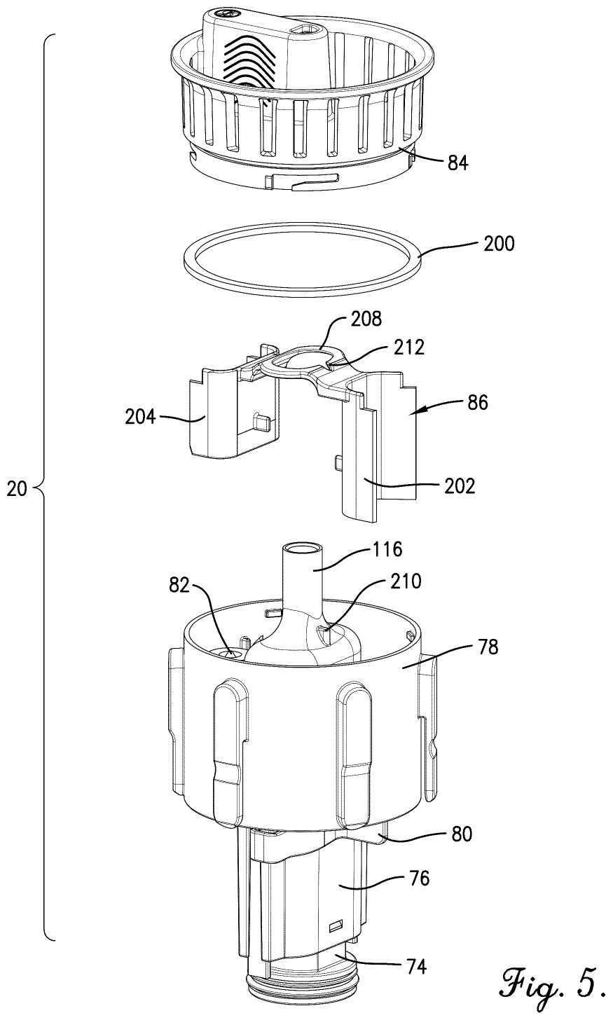

FIG. 5 an exploded view of selected components of a cartridge assembly of the device of FIG. 1;

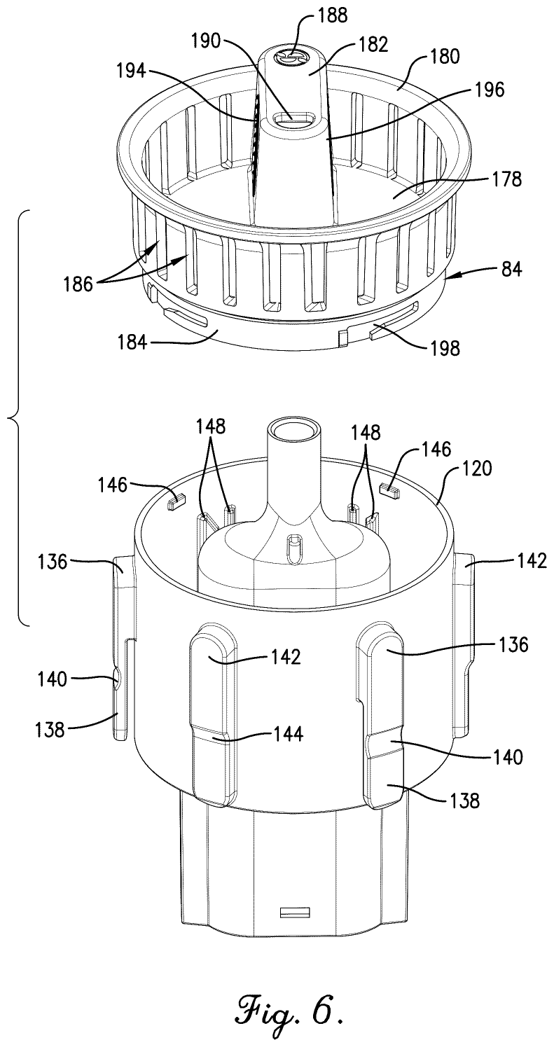

FIG. 6 is an exploded view of a collector and basket of the cartridge assembly of FIG. 5;

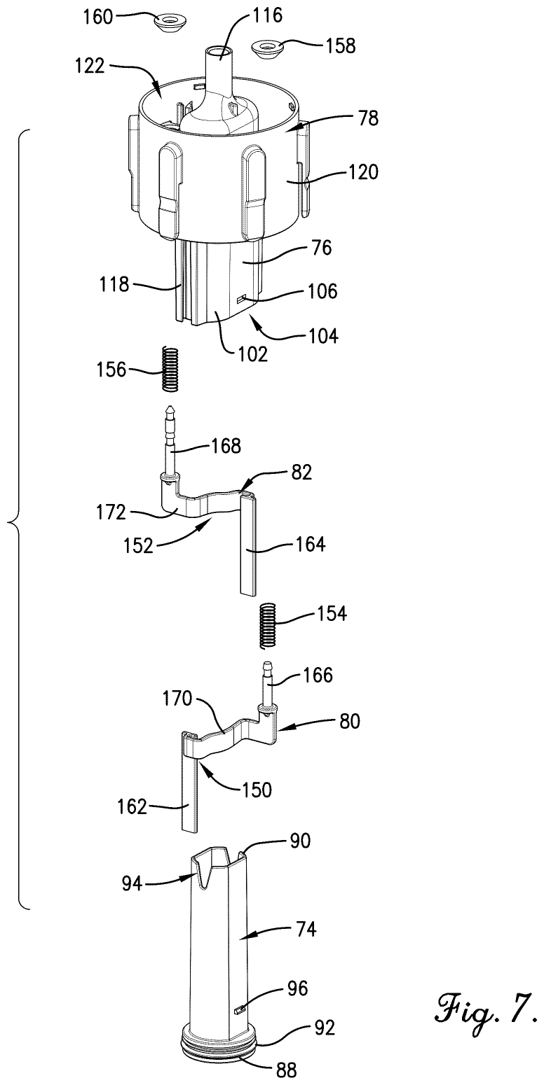

FIG. 7 is an exploded view of the collector, an outlet tube, and valves of the cartridge assembly of FIG. 5;

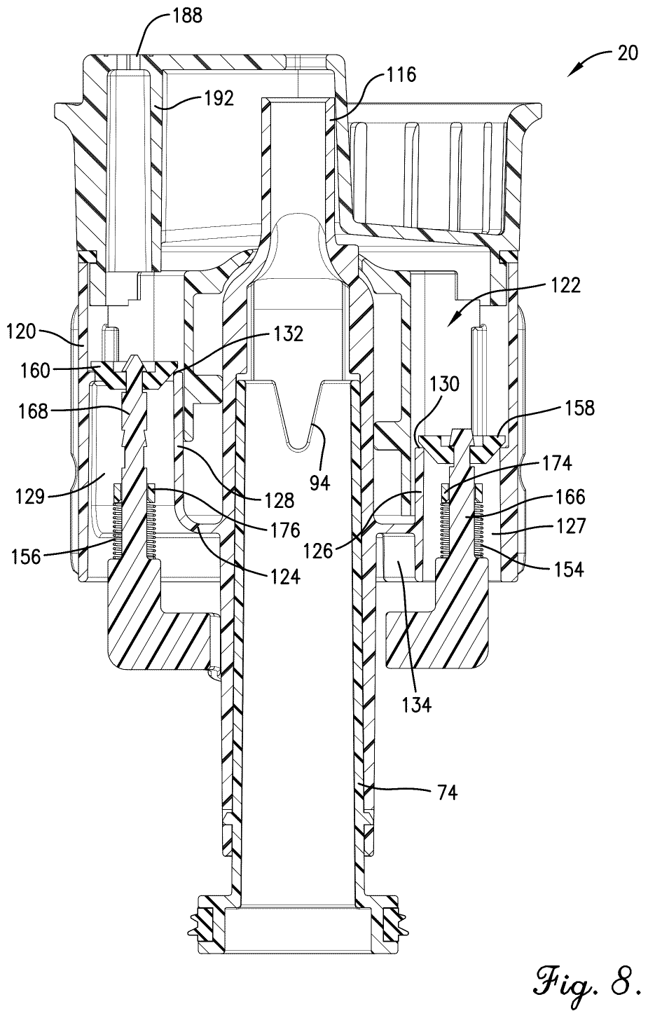

FIG. 8 is a sectional view of the cartridge assembly viewed along lines 8-8 in FIG. 3, the cartridge assembly being removed from the basin assembly with the valves in the closed position;

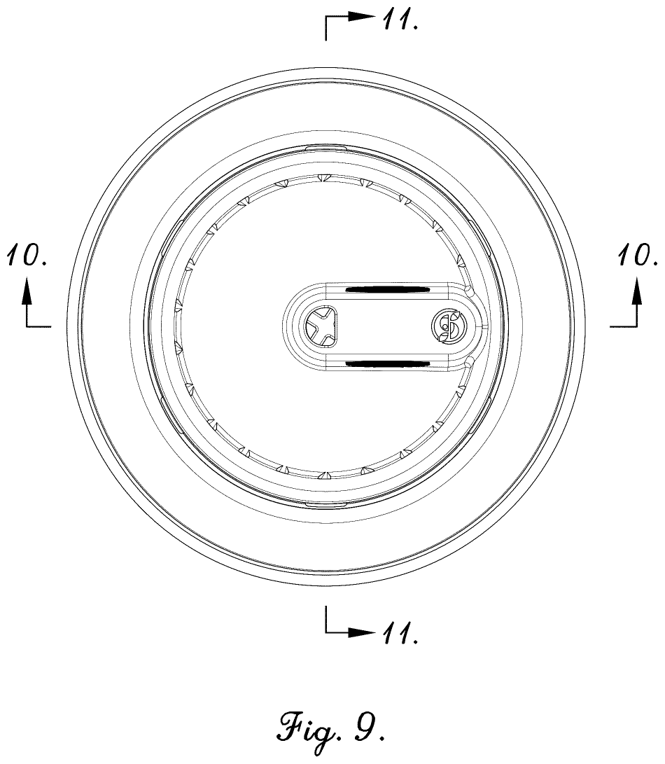

FIG. 9 is a top plan view of the device of FIG. 1;

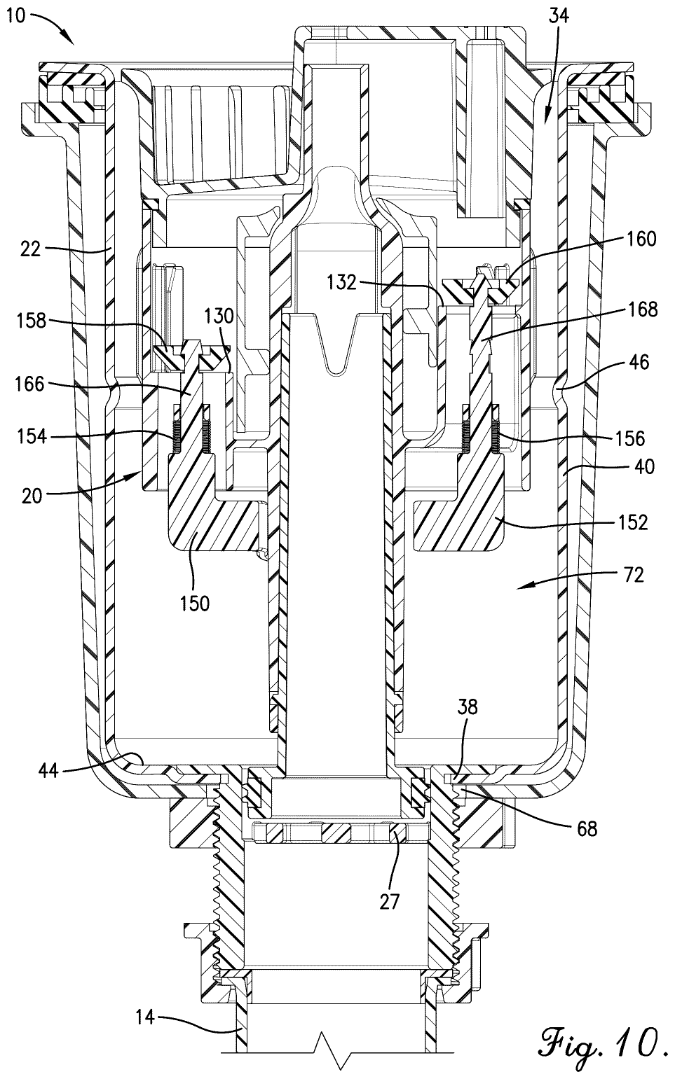

FIG. 10 a sectional view of the device viewed along lines 10-10 in FIG. 9;

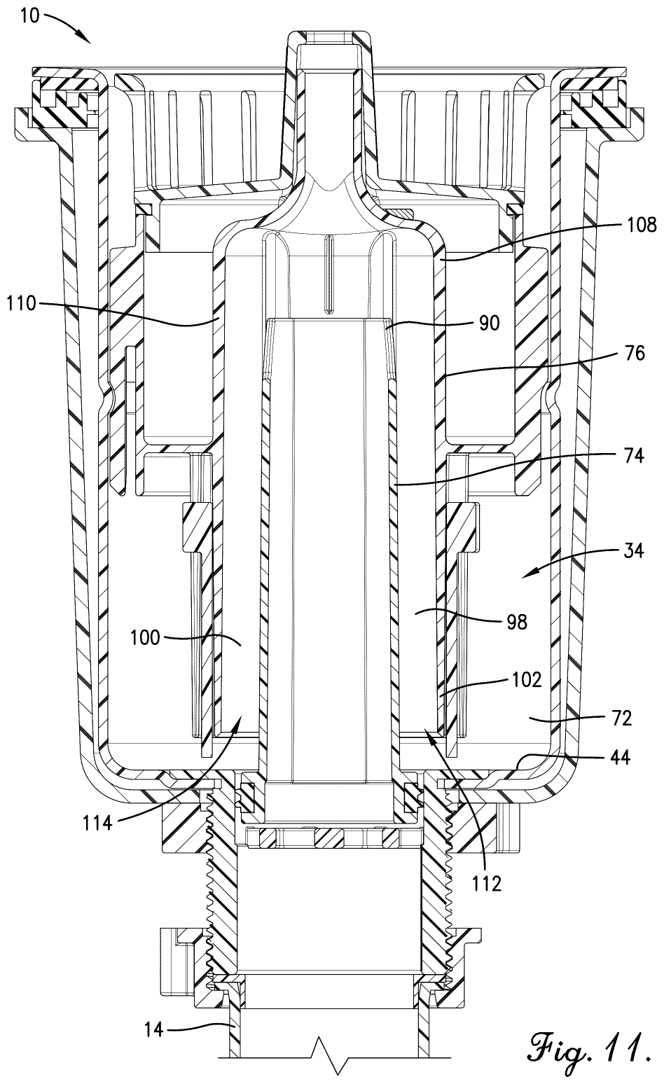

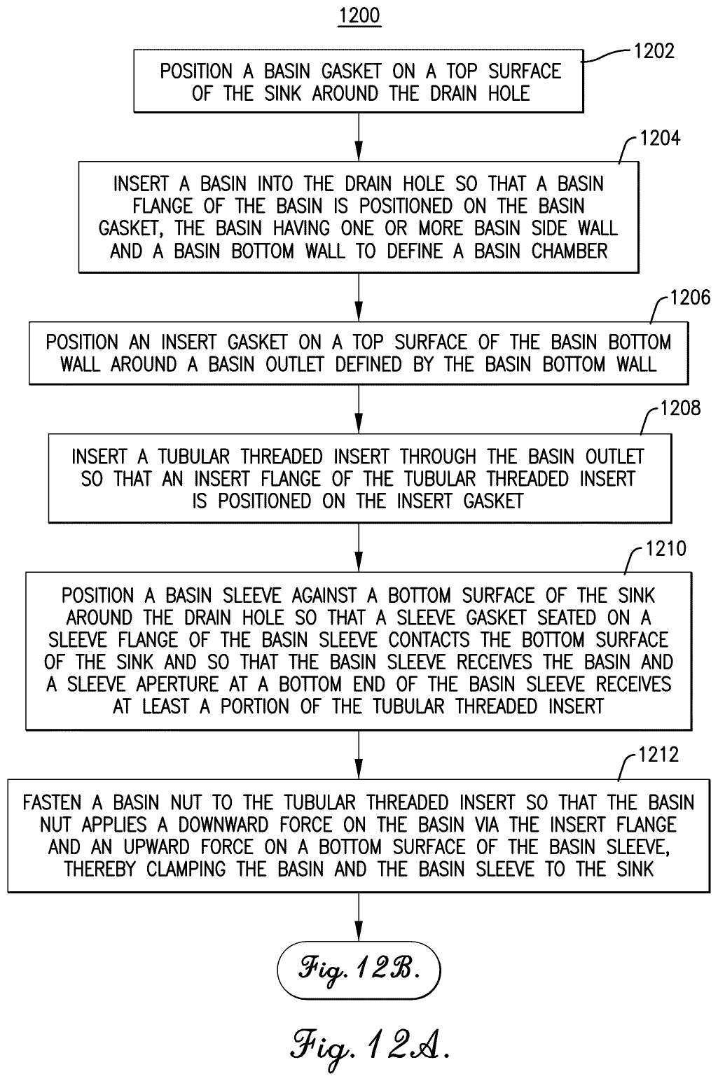

FIG. 11 a sectional view of the device viewed along lines 11-11 in FIG. 9; and

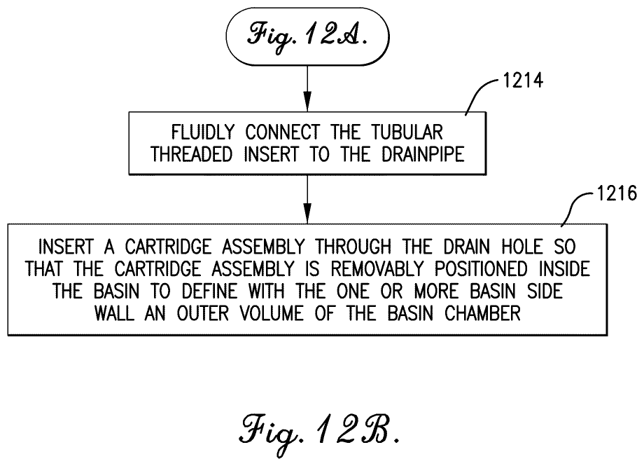

FIGS. 12A and 12B depict a flowchart having exemplary steps of a method of installing a filtration device according to an embodiment of the present invention.

The drawing figures do not limit the current invention to the specific embodiments disclosed and described herein. The drawings are not necessarily to scale, emphasis instead being placed upon clearly illustrating the principles of the invention.

### DETAILED DESCRIPTION

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

Turning to FIG. 1, a device 10 constructed according to an embodiment of the present invention is depicted with the device 10 being connected to a sink 12 and to a drainpipe 14. The sink 12 may be any type of sink known in the art, such as a kitchen sink, an industrial sink, a commercial sink, a residential sink, a top-mount sink, an under-mount sink, a farmhouse sink, an integrated sink, a vessel sink, a wall-mounted sink, a pedestal sink, a console sink, a bar sink, a corner sink, a double basin sink, a single basin sink, or the like. Turning to FIG. 2, the device 10 is coupled to a drain hole 16 of the sink 12 and receives fluid that has drained from the sink 12, separates solids, grease, and other substances from the fluid, and directs the waste fluid to the drainpipe 14. While the device 10 is depicted as being connected to a sink, the device can be connected to other fixtures, waste lines, etc. For example, the device 10 may be connected to a dishwasher waste line and/or a discharge tube. Turning to FIG. 3, in one or more embodiments, the device 10 comprises a basin assembly 18 and a cartridge assembly 20 operable to be removably coupled to the basin assembly 18.

Turning to FIG. 4, in one or more embodiments, the basin assembly 18 is operable to couple to the sink 12 and the drainpipe 14 and comprises a basin 22, a tubular threaded insert 24, a basin sleeve 26, a basin gasket 28, a sleeve gasket 30, and a basin nut 32. The basin 22 is operable to receive the fluid from the sink 12 and defines a basin chamber 34, a basin inlet 36 through which fluid from the drain hole 16 can flow into the basin chamber 34, and a basin outlet 38 (depicted in FIG. 10) through which the fluid can exit the basin chamber 34 by way of the threaded insert 24. The basin 22 includes one or more basin side wall 40, a basin flange 42 connected to the top of the basin side wall 40, and a basin bottom wall 44 connected to the bottom end of the basin side wall 40 and defining the basin outlet 38. While the basin 22 is depicted as being tubular, the basin 22 may have any number of shapes without departing from the scope of the present invention. In one or more embodiments, the basin side wall 42 has one or more projections 46 (best viewed in FIG. 10) radially inwardly extending to form a detent for releasably coupling with one or more catch of the cartridge assembly 20, as discussed in further detail below.

The tubular threaded insert 24 is operable to help clamp the basin 22 and the basin sleeve 26 to the sink 12 and to connect the device 10 to the drainpipe 14. The threaded insert 24 has a bottom end 48 operable to be inserted through the basin outlet 38 and a top end 50 having an insert flange 52 operable to rest on the basin bottom wall 44 when the bottom end 48 is inserted through the basin outlet 38. In one or more embodiments, an insert gasket 25 is positioned between the insert flange 52 and the bottom wall 44 of the basin 22.

The threaded portion of the insert 24 is operable to extend through the basin outlet 38 and an aperture of the basin sleeve 26. This allows the basin nut 32 to be fastened to the threaded portion of the insert 24 to pull the insert 24 downwards so that the insert flange 52 pulls against the bottom wall 44 of the basin 22. This downward force pulls the flange 42 of the basin 22 against the basin gasket 28. Simultaneously, the basin nut 32 pushes upwards against a bottom surface of the basin sleeve 26, which causes a flange of the basin sleeve 26 to push against the sleeve gasket 30. These opposing forces clamp the basin and sleeve gaskets 28, 30 against opposing surfaces of the portion of the sink 12 around the drain hole 16, thereby helping form a fluidly sealed connection between the sink 12 and the device 10. In one or more embodiments, the top end 50 of the insert 24 defines an inlet for receiving a portion of the cartridge assembly 20, as discussed in further detail below. The insert 24 may include one or more additional solids filtering structures 27 (depicted in FIG. 10) located inside its passageway and extending diametrically across the channel defined by the tubular threaded insert 24. The filtering structures 27 help prevent passage of solids while also providing a surface on which an end of the cartridge assembly 20 may rest, as discussed in further detail below.

In one or more embodiments, the lower end 48 of the threaded insert 24 is operable to be connected to the drainpipe 14. Turning briefly back to FIG. 3, the drainpipe 14 may include flange 54, and a drainpipe nut 56 may be fastened to the threaded insert 24 to couple the drainpipe 14 to the threaded insert 24 with a drainpipe gasket 58 providing a sealed connection between the drainpipe 14 and the threaded insert 24. However, the threaded insert 24 may be configured to be connected to a drainpipe 14 any number of ways without departing from the scope of the present invention.

Turning back to FIG. 4, the basin sleeve 26 helps clamp the basin 22 to the sink 12. The basin sleeve 26 includes a top end defining a sleeve opening 60 operable to receive at least a portion of the basin 22. The basin sleeve 26 includes a sleeve flange 62 with a rim 64 that defines a seat for receiving the sleeve gasket 30. The basin sleeve 26 further includes a bottom wall 66 defining a sleeve aperture 68 (as viewed in FIG. 10) operable to receive at least a portion of the tubular threaded insert 24.

As mentioned above, the basin gasket 28 and the sleeve gasket 30 are provided for helping form a sealed connection between the sink 12 and the device 10. The gaskets 28, 30 are made of resilient material, such as rubber or the like, for providing a flexible seal. The basin gasket 28 is positioned between the basin flange 42 and a top surface of the sink 12 around the drain hole 16. The sleeve gasket 30 can be seated on the sleeve flange 62 inside the rim 64 and sandwiched between the sleeve flange 62 and a bottom surface of the sink 12 around the drain hole 16. In one or more embodiments, the sleeve gasket 30 includes one or more concentric upwardly extending walls 70 for helping form the watertight connection. The basin nut 32 is configured to be fastened to the tubular threaded insert 24 to provide the clamping force between the basin sleeve 26 and the basin 22. The basin nut 32 may include an internal surface with threads corresponding to the threads of the insert 24.

While the figures depict the components of the basin assembly 18 being separate components, some of the components may be integrated without departing from the scope of the present invention. For example, the tubular threaded insert 24 may be integrated with the basin 22.

Turning to FIG. 5, in one or more embodiments, the cartridge assembly 20 is sized to fit through the drain hole 16 and is removably coupled with the basin assembly 18 inside the basin chamber 34 to define an outer and/or lower volume 72 (as depicted in FIG. 10) of the basin chamber 34 with the basin side wall 40. In one or more embodiments, the cartridge assembly 20 comprises a cartridge outlet tube 74, an outlet housing 76, a collector 78, one or more valves 80, 82, a basket 84, and a cartridge diverter 86.

Turning to FIG. 7, in one or more embodiments, the cartridge outlet tube 74 at least partially defines one or more flow path for fluid to travel from the lower volume 72 in the basin 22 through the basin outlet 38 (by way of the threaded insert 24 extending through the basin outlet 38 and to the drainpipe 14). The cartridge outlet tube 74 is configured to allow fluid to partially fill the basin chamber 34 so that grease and other substances floating on top of the fluid are directed into the collector 78. In one or more embodiments, the one or more flow paths at least partially defined by the outlet tube 74 is s-shaped so that the fluid travels from the sink 12 down into the basin chamber 34, upwards into the outlet tube 74, and down through the outlet tube 74. However, the flow path formed by components of the cartridge assembly 20 may be defined to form any number of shapes without departing from the scope of the present invention.

In one or more embodiments, the cartridge outlet tube 74 is operable to be at least partially positioned in the basin chamber 34 and has a lower end defining a tube outlet 88 through which the fluid can flow through the basin outlet 38 and an upper end defining a tube inlet 90. In one or more embodiments, the cartridge outlet tube 74 has a gasket 92 coupled with the lower end of the tube 74 and configured to abut against an inner surface of the tubular threaded insert 24. This provides a sealed connection between the cartridge outlet tube 74 and the insert 24, which is sealed against the basin bottom wall 44. Thus, in one or more embodiments, the fluid must flow through the cartridge outlet tube 74 in order to exit the basin 22 through the basin outlet 38. Additionally, the filtering structures 27 of the insert 24 may be configured to support the cartridge outlet tube 74 when the cartridge outlet tube 74 and/or the rest of the cartridge assembly 20 is inserted in the basin assembly 18.

The upper end of the cartridge outlet tube 74 may define one or more notches 94 in the tube inlet 90. In one or more embodiments, the tube inlet 90 is in a spaced relationship above the basin bottom wall 44 when the cartridge assembly 20 is positioned in the basin assembly 18. In other words, the tube inlet 90 may be located at a higher elevation than the basin bottom wall 44 and/or located higher along an imaginary axis extending from the drainpipe 14 to the sink 12. The tube inlet 90 may be located at a first distance relative to the basin bottom wall 44 when the cartridge assembly 20 is positioned in the basin chamber 34. In one or more embodiments, the outlet tube 74 includes one or more projections 96 serving as detent structures for coupling to corresponding catches formed in the outlet housing 76. While the cartridge outlet tube 74 is depicted as having two curved walls connected to two planar opposing walls, the cartridge outlet tube 74 can have any shape without departing from the scope of the present invention.

In one or more embodiments, the outlet housing 76 helps define the flow path of the fluid to help direct primarily the fluid—and not grease or other substances floating on the fluid—to the drainpipe 14. In one or more embodiments, the outlet housing 76 has a lower end 102 that defines an opening 104 that receives the outlet tube 74. The lower end 102 further includes one or more apertures 106 that function as catches corresponding to the projections 96 of the outlet tube 74 to couple the outlet housing 76 and the collector 78 to the outlet tube 74.

Turning briefly to FIG. 11, in one or more embodiments, the outlet housing 76 connects to the outlet tube 74 so that the lower end 102 of the outlet housing 76 is in a spaced relationship with the basin bottom wall 44. The outlet housing 76 includes outer walls 108, 110 that at least partially define one or more housing channels 98, 100 fluidly connecting the outer volume 72 of the basin chamber 34 to the tube inlet 90. The housing channels 98, 100 having housing channel inlets 112, 114 located below the tube inlet 90. In other words, the housing channel inlets 112, 114 are in a spaced relationship below the tube inlet 90 in terms of elevation and/or along the imaginary axis extending from the drainpipe 14 to the sink 12. The housing channel inlets 112, 114 may be located a second distance relative to the basin bottom wall 44. The second distance may be shorter than the first distance (the distance between the basin bottom wall 44 and the tube inlet 90).

Turning back to FIG. 7, in one or more embodiments, the outlet housing 76 includes an air inlet nozzle 116 that is in fluid communication with a spout hole of the basket 84 (discussed below) and the flow path of the fluid. This helps prevent siphoning of the fluid in the basin chamber 34. When coupled to the outlet tube 74, the air inlet nozzle 116 may be located above collector channel outlets (discussed below) and is operable to be in fluid communication with the tube inlet 90. In one or more embodiments, the outlet housing 76 includes tracks 118 that define slots for receiving portions of the valves 80, 82, as discussed below.

The collector 78 includes one or more side walls 120 at least partially defining a collector chamber 122 for accumulating grease and other substances floating in the fluid in basin chamber 34. In one or more embodiments, the collector 78 is integrally connected to the outlet housing 76 and extends around a portion thereof. Turning to FIG. 8, the collector 78 includes a collector bottom wall 124 connected to the side wall 120 to help define the collector chamber 122. In one or more embodiments, the collector bottom wall 124 is located above the housing channel inlets 112, 114 when the outlet housing 76 and collector 78 are connected to the outlet tube 74. In other words, the collector bottom wall 124 is located in a spaced relationship above the housing channel inlets 112, 114 in terms of elevation and/or along the imaginary axis extending from the drainpipe 14 to the sink 12 when the outlet housing 76 and collector 78 are connected to the outlet tube 74 and positioned in the basin 22. The collector bottom wall 124 may be at a third distance relative to the basin bottom wall 44 that is longer than the second distance (distance between the housing channel inlets 112, 114 and the basin bottom wall 44) when the outlet housing 76 and collector 78 are connected to the outlet tube 74 and positioned in the basin 22.

In one or more embodiments, the collector 78 may include one or more internal walls 126, 128 or vertically extending tubes that at least partially define one or more collector channels 127, 129 fluidly connecting the outer volume 72 to the collector chamber 122. The collector channels 127, 129 have collector channel outlets 130, 132 through which fluid (including grease or other substances floating thereon) from the outer/lower volume 72 flows into the collector chamber 122. The collector channel outlets 130, 132 are located above the collector bottom wall 124 to help prevent the grease and other substances from flowing back into the lower volume 72 of the basin chamber 34. In other words, the collector channel outlets 130, 132 may be in a spaced relationship above the collector bottom wall 124 in terms of elevation and/or along the imaginary axis extending from the drainpipe 14 to the sink 12. The collector channel outlets 130, 132 may also be located at a fourth distance relative to the basin bottom wall 44 that is longer than the third distance (the distance between the collector bottom wall 124 and the basin bottom wall 44) when the collector 78 is positioned in the basin 22.

The air inlet nozzle 116 is in a spaced relation above the collector channel outlets 130, 132 to help prevent the grease or other substances from overflowing into the nozzle 116 and down through the outlet tube 74. In other words, the air inlet nozzle 116 is located above the collector channel outlets 130, 132 in terms of elevation and/or along the imaginary axis extending from the drainpipe 14 to the sink 12. The inlet of the air inlet nozzle 116 may be located at a distance relative to the basin bottom wall 44 that is longer than the fourth distance (the distance between the collector channel outlets 130, 132 and the basin bottom wall 44) when the collector 78 is positioned in the basin 22.

In one or more embodiments, the collector channel outlets 130, 132 may be at different elevations to allow for grease to be collected in the offset of the two heights. One of the collector channel outlets 130 may be at a substantially similar elevation as a bottom most point of the notches 94, and the other collector channel outlet 132 may be positioned at or above the top end of the outlet tube 74 or at or above the location of the tube inlet 90. In one or more embodiments, the collector bottom wall 124 may include a downwardly extending hollow projection 134 defining a collector depression next to the collector channel 127 having a collector channel outlet 130 at the lower elevation.

Turning to FIG. 6, the collector 78 is sized to fit through the drain hole 16 of the sink 12 and is operable to be removably positioned in the basin chamber 34. In one or more embodiments, the collector 78 has one or more projections 136 extending radially outwardly from an outer surface of the collector side wall 120 with downwardly extending tabs 138. The tabs 138 are made of resilient material, such as plastic or the like, and are operable to bend radially inwardly toward the collector side wall 120 and resiliently retract back to their original positions. The tabs 138 include depressions 140 acting as catches configured to releasably couple to the inwardly extending projections 46 or detents of the basin 22. The collector 78 may also include one or more guide ribs 142 having stops 144 aligned with the depressions 140 circumferentially about the collector wall 120 and operable to abut against the projection 46 of the basin 22 to prevent the collector 78 from being inserted too far into the basin 22.

In one or more embodiments, the collector 78 includes structures for connecting with other components of the cartridge assembly 20. The collector 78 may include one or more projections 146 extending radially inwardly from the inner surface of the collector wall 120 for sliding into corresponding slots of the basket 84, as discussed below. The collector 78 may also include fins 148 extending radially inwardly from an internal surface of the collector side wall 120 and extending vertically along the internal surface to define slots for receiving portions of the cartridge diverter 86, as discussed below.

While the figures depict the collector 78 and outlet housing 76 being integrated into a single piece, the collector 78 and outlet housing 76 may be separate pieces without departing from the scope of the present invention.

Turning back to FIG. 7, the valves 80, 82 are operable to shift between closed positions (depicted in FIG. 8) in which the valves 80, 82 block the collector channels 127, 129 and open positions (depicted in FIG. 10) in which the valves 80, 82 do not block the collector channels 127, 129. The valves 80, 82 are configured to shift to the open positions when the collector 78 is positioned in the basin chamber 34 to allow fluid, grease, and other substances to flow into the collector chamber 122. The valves 80, 82 are configured to shift to the closed positions when the collector 78 is removed from the basin chamber 34 to prevent fluid, grease, and other substances from flowing out of the collector channels 127, 129. This helps prevent the collector 78 from leaking when removing and emptying the collector 78 of the accumulated grease and other substances located in the collector chamber 122. In one or more embodiments, the valves 80, 82 comprise cartridge rods 150, 152, biasing elements 154, 156, and valve gaskets 158, 160 operable to block the collector channels 127, 129 when the valves are in the closed positions.

The cartridge rods 150, 152 are slidably connected to the collector 78 and the outlet housing 76. The cartridge rods 150, 152 include elongated tongues 162, 164, stems 166, 168 extending into the collector channels 127, 129, and transition portions 170, 172 connecting the tongues 162, 164 and the stems 166, 168. The tongues 162, 164 are operable to be inserted into and slide vertically within the slots defined by the tracks 118 of the outlet housing 76. The bottom ends of the tongues 162, 164 are configured to abut a portion of the basin 22 when the collector 78 is positioned in the basin chamber 34 to shift the rods 150, 152 and therefore the valves 80, 82 to the open positions. In one or more embodiments, the bottom ends of the tongues 162, 164 abut the basin bottom wall 44 when the cartridge assembly 20 is coupled to the basin assembly 18 to shift the valves 80, 82 to the open positions.

Turning to FIG. 8, the valves 80, 82 are depicted in the closed positions with the cartridge assembly 20 removed from the basin assembly 18. The stems 166, 168 extend into the collector channels 127, 129, are coupled to the valve gaskets 158, 160, and are biased downwards by the biasing elements 154, 156 so that the valve gaskets 158, 160 block the collector channel outlets 130, 132. The collector 78 may include channel guide loops 174, 176 extending from the internal walls 126, 128 that receive the stems 166, 168 and against which the biasing elements 154, 156 press to bias the cartridge rods 150, 152 downwards relative to the collector 78.

Turning to FIG. 10, the valves 80, 82 are depicted in the open positions with the cartridge assembly 20 positioned in the basin assembly 18. The bottom ends of the cartridge rods 150, 152 push against the basin bottom wall 44 to overcome the biasing force of the biasing elements 154, 156 so that the stems 166, 168 and valve gaskets 158, 160 extend above the collector channel outlets 130, 132. As depicted, the biasing elements 154, 156 may include compression springs; however, the biasing elements 154, 156 may be any other type of biasing clement and configured any number of ways relative to the cartridge rods 150, 152 without departing from the scope of the present invention.

Turning back to FIG. 6, the basket 84 is operable to be positioned through the drain hole 16 of the sink 12 and collect solids while allowing fluid to flow into the basin assembly 18. In one or more embodiments, the basket 84 is connected to the collector 78 and comprises a basket base wall 178, one or more basket side wall 180, a spout protrusion 182, and a spigot portion 184. In one or more embodiments, the basket 84 is removably connected to the collector 78. The basket base wall 178 at least partially covers the collector chamber 122.

The basket side wall 180 extends upwardly from the base wall 178 and defines one or more basket apertures 186 through which fluid can flow from inside the basket 84 and into the outer volume 72 of the basin chamber 34.

The spout protrusion 182 extends from the base wall 178 above the basket side wall 180 and includes a spout hole 188 and an air inlet hole 190. The spout hole 188 is in fluid communication with the collector chamber 122 when the basket 84 is connected to the collector 78 for allowing grease and/or other substances to flow out of the chamber 122 for quick emptying of the collector 78 without having to detach the basket 84. The spout protrusion 182 may be hollow and include one or more internal walls 192 (depicted in FIG. 8) defining a channel through which grease and other substances can flow through to the spout hole 188. The air inlet hole 190 may be located above and coaxial with the air inlet nozzle 116 of the outlet housing 76 to allow airflow into the air inlet nozzle 116. The air inlet nozzle 116 may extend into the protrusion 182 when the basket 84 is attached to the collector 78. In one or more embodiments, the spout protrusion 182 is sized to extend above the bottom surface of the sink 12 so that it can be readily grasped and to help prevent water from flowing directly down the air inlet nozzle 116, thereby bypassing the filtering structures of the device 10. The spout protrusion 182 may include two opposing walls with grip structures 194, 196 formed on external surfaces of the opposing walls. The grip structures 194, 196 may comprise outwardly extending projections, grooves formed in the walls, or the like. The grip structures 194, 196 allow a user to readily grasp the basket 84 to pull the entire cartridge assembly 20 out of the basin assembly 18 when the basket 84 is connected to the collector 78.

The spigot portion 184 extends downwardly from the basket bottom wall 178 and is sized to fit inside the collector 78. The spigot portion 184 includes connecting structure corresponding to the collector 78. In one or more embodiments, the spigot portion 184 has grooves 198 formed therein for receiving the projections 146 of the collector 78. The grooves 198 are shaped to receive the projections 146 vertically and then allow the basket 84 to rotate axially relative to the collector 78 so that the projections are received into circumferentially extending portions of the grooves 198. However, the basket 84 and the collector 78 may be releasably connected any number of ways without departing from the scope of the present invention.

Turning to FIG. 5, in one or more embodiments, a basket seal 200 is positioned between the basket bottom wall 178 and the lip of the collector 78. The cartridge diverter 86 is removably coupled to the collector 78 and/or the outlet housing 76. The cartridge diverter 86 is configured to help prevent grease or other substances floating at the top of fluid in the collector chamber 122 from flowing back through the collector channels 127, 129. The cartridge diverter 86 includes two vertically extending c-channels 202, 204 and a bridge portion 206 connecting the two c-channels 202, 204. The ends of the c-channels 202, 204 are operable to be inserted into the slots defined by the fins 148 of the collector 78. The bridge portion 206 includes an aperture 208 for receiving the air inlet nozzle 116. In one or more embodiments, the outlet housing 76 includes a key 210 corresponding to a key seat 212 formed in the aperture 208 for ensuring proper alignment of the cartridge diverter 86 in the collector 78.

While the figures depict the components of the basin assembly and the cartridge assembly comprising separate components, some of the components may be integrated without departing from the scope of the present invention. For example, the cartridge outlet tube may be integrated with the basin. Additionally or alternatively, the cartridge diverter may be integrated with the collector. Further, one or more of the gaskets may be replaced by any other suitable material, such as a sealant, adhesive, or the like. Further, one or more of the gaskets may be integrated into one or more of the components. Additionally, only the basin of the basin assembly may be connected to the sink using an adhesive, such as plumber's putty or any other suitable compound. Additionally, the basin sleeve may be any shape without departing from the scope of the present invention. It should still further be understood that the components of the device 10 in accordance with embodiments of the present invention may be formed of a variety of suitable materials, including polymers or plastics, metals, composites, and the like (e.g., fiberglass reinforced composites, etc.) using any suitable method for preparing the structures described herein.

Turning to FIG. 10, when the cartridge assembly 20 is positioned in the basin assembly 18 during operation, the fluid from the sink 12 flows into the basin chamber 34 along the interior of the basin wall 40 and/or along the outer surface of the collector 78 from the basket 84. By flowing along the full perimeter of the basin inlet, the velocity of the fluid is slowed, which creates a calmer incoming flow into the lower volume 72 of the basin 22. Solids in the fluid from the sink are collected in the basket 84. The fluid flows into the lower volume 72 of the basin chamber 34. As the lower volume 72 is filled with the fluid, grease and other substances floating in the fluid are directed up through the collector channels 127, 129 and into the collector chamber 122. Turning to FIG. 11, as the collector chamber 122 is filled with grease and other substances and as the lower volume 72 of the basin chamber 34 is filled with the fluid, the fluid is drained from the basin 22 by being directed up through the housing channel inlets 112, 114 and into the tube inlet 90 of the cartridge outlet tube 74. From there, the fluid flows down through the cartridge outlet tube 74, through the insert 24, and out to the drainpipe 14. Turning to FIG. 8, when the collector 78 is to be emptied, the cartridge assembly 20 is removed from the basin assembly 18, which causes the valves 80, 82 to close. The basket 84 can be removed from the collector 78 (as depicted in FIG. 6) so that the collector chamber 122 can be emptied of the grease and/or other substances and cleaned.

The flow chart of FIGS. 12A and 12B depict the steps of an exemplary method 1200 of installing a sink filtration device to a drain hole of a sink and to a drainpipe. In some alternative implementations, the functions noted in the various blocks may occur out of the order depicted in FIGS. 12A and 12B. For example, two blocks shown in succession in FIGS. 12A and 12B may in fact be executed substantially concurrently, or the blocks may sometimes be executed in the reverse order depending upon the functionality involved. In addition, some steps may be optional. The method 1200 is described below, for case of reference, as being executed with the exemplary devices and components introduced with the embodiments illustrated in FIGS. 1-11; however, the method 1200 may be implemented with other devices and components without departing from the scope of the present invention.

Referring to step 1202, the basin gasket is positioned on a top surface of the sink around the drain hole. The basin gasket may be positioned so that it is generally coaxial with the drain hole of the sink.

Referring to step 1204, the basin is inserted into the drain hole so that the basin flange is positioned on the basin gasket. The basin may be generally centered within the drain hole.

Referring to step 1206, the insert gasket is positioned on the top surface of the basin bottom wall around the basin outlet. This step may be performed prior to inserting the basin into the drain hole.

Referring to step 1208, the tubular threaded insert is inserted through the basin outlet so that the insert flange is positioned on the insert gasket. This step may also be performed prior to inserting the basin into the drain hole.

Referring to step 1210, the basin sleeve is positioned against the bottom surface of the sink around the drain hole to receive at least a portion of the basin. The basin sleeve may be positioned so that the sleeve gasket seated on the sleeve flange contacts the bottom surface of the sink. Additionally, the basin sleeve may be positioned so that the sleeve aperture receives at least a portion of the tubular threaded insert.

Referring to step 1212, the basin nut is fastened to the tubular threaded insert extending below the basin sleeve. The basin nut is fastened so that it applies a downward force on the basin via the insert flange and an upward force on a bottom surface of the basin sleeve, thereby clamping the basin and the basin sleeve to the sink with the basin and sleeve gaskets on opposing sides of the sink to form a watertight seal.

Referring to step 1214, the tubular threaded insert is fluidly connected to the drainpipe. The tubular threaded insert may be connected to the drainpipe using a flanged drainpipe, a drainpipe gasket, and a drainpipe nut. However, the tubular threaded insert may be connected to the drainpipe any number of ways without departing from the scope of the present invention.

Referring to step 1216, the cartridge assembly is inserted through the drain hole so that the cartridge assembly is removably positioned inside the basin. The cartridge assembly may be positioned so that the cartridge outlet tube has a lower end extending into a portion of the tubular threaded insert and forming a watertight seal with via a gasket. In one or more embodiments, this step may include assembling the cartridge assembly prior to inserting the cartridge assembly into the basin. In one or more embodiments, this step may include inserting the cartridge outlet tube through the drain hole so that the cartridge outlet tube extends into the portion of the tubular threaded insert, and then connecting the outlet housing and the collector to the cartridge outlet tube.

The method 1200 may include additional, less, or alternate steps and/or device(s), including those discussed elsewhere herein.

Although the above description presents features of preferred embodiments of the present inventive concept, other preferred embodiments may also be created in keeping with the principles of the invention. Furthermore, these other preferred embodiments may in some instances be realized through a combination of features compatible for use together despite having been presented independently in the above description.

Furthermore, directional references (e.g., top, bottom, front, back, up, down, etc.) are used herein solely for the sake of convenience and should be understood only in relation to each other. For instance, a component might in practice be oriented such that faces referred to as “top” and “bottom” are sideways, angled, inverted, etc. relative to the chosen frame of reference.

It is further noted that the term annular or aperture shall be interpreted to mean that the referenced object or structure extends around a central opening so as to be generally toroidal or ring-shaped. It is not necessary for the object to be precisely circular, nor does the object have to be continuous. Similarly, the term toroidal shall not be interpreted to mean that the object must be circular or continuous, as other geometries may be used including oval, polygonal, rectangular, etc. depending upon the particular feature design.

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, the phrase “and/or,” when used in a list of two or more items, means that any one of the listed items can be employed by itself or any combination of two or more of the listed items can be employed. For example, if a composition is described as containing or excluding components A, B, and/or C, the composition can contain or exclude A alone; B alone; C alone; A and B in combination; A and C in combination; B and C in combination; or A, B, and C in combination.

The present description also uses numerical ranges to quantify certain parameters relating to various embodiments of the invention. It should be understood that when numerical ranges are provided, such ranges are to be construed as providing literal support for claim limitations that only recite the lower value of the range as well as claim limitations that only recite the upper value of the range. For example, a disclosed numerical range of about 10 to about 100 provides literal support for a claim reciting “greater than or equal to about 10” (with no upper bounds) and a claim reciting “less than or equal to about 100” (with no lower bounds).

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Furthermore, unless otherwise specified, any directional references (e.g., upper, lower, above, below, etc.) are used herein solely for the sake of convenience and should be understood only in relation to each other. For instance, a component might in practice be oriented such that faces referred to as “upper” and “lower” are sideways, angled, inverted, etc. relative to the chosen frame of reference.

The patent claims at the end of this patent application are not intended to be construed under 35 U.S.C. § 112(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A device for coupling to a drain hole of a sink and a to drainpipe, the device comprising:
a basin defining a basin chamber, a basin inlet through which fluid from the drain hole can flow into the basin chamber, and a basin outlet through which the fluid can exit the basin chamber;
a cartridge outlet tube at least partially positioned in the basin chamber and having a lower end defining a tube outlet through which the fluid can flow through the basin outlet and an upper end defining a tube inlet;
an outlet housing at least partially defining a housing channel fluidly connecting an outer volume of the basin chamber to the tube inlet, the housing channel having a housing channel inlet located below the tube inlet; and
a collector defining a collector chamber in the basin chamber and having a collector bottom wall located above the housing channel inlet, the collector defining one or more collector channel fluidly connecting the outer volume to the collector chamber, the one or more collector channel having a collector channel outlet through which fluid flows into the collector chamber from the outer volume, the collector channel outlet being located above the collector bottom wall.

2. The device of claim 1, further comprising a basket removably connected to the collector, the basket comprising a base wall at least partially covering the collector chamber and one or more basket side wall extending from the base wall and defining one or more basket aperture through which fluid can flow from inside the basket into the outer volume of the basin chamber.

3. The device of claim 1, wherein the outlet housing includes an air inlet nozzle extending above the collector channel outlet and operable to be in fluid communication with the drain hole and the tube inlet.

4. The device of claim 1, wherein the basin include a basin flange and a basin bottom wall defining a basin outlet, further comprising:
a tubular threaded insert having a bottom end operable to be inserted through the basin outlet and a top end having a flange operable to rest on the basin bottom wall when the bottom end is inserted through the basin outlet, wherein the lower end of the cartridge outlet tube is connected to the tubular threaded insert;
a basin sleeve including a top end having a sleeve opening operable to receive at least a portion of the basin and having a sleeve flange, the basin sleeve including a bottom end with a sleeve aperture operable to receive at least a portion of the tubular threaded insert;
a basin gasket for positioning between the basin flange and a top surface of the sink around the drain hole;
a sleeve gasket for positioning between the sleeve flange and a bottom surface of the sink around the drain hole; and
a basin nut configured to be fastened to the tubular threaded insert to clamp the basin sleeve and the basin flange to the sink.

5. The device of claim 4, wherein the lower end of the cartridge outlet tube has a gasket configured to abut an inner surface of the tubular threaded insert.

6. The device of claim 4, wherein the tubular threaded insert is operable to be connected to the drainpipe.

7. The device of claim 1, wherein the collector is configured to be removably coupled to the basin and is sized to fit through the drain hole.

8. A device for coupling to a drain hole of a sink and to a drainpipe, the device comprising:
a basin defining a basin chamber, a basin inlet through which fluid from the drain hole can flow into the basin chamber, and a basin outlet through which the fluid exits the basin chamber; and
a collector sized to fit through the drain hole and operable to be removably positioned in the basin chamber, the collector defining a collector chamber in the basin chamber and having a collector bottom wall located at a distance relative to the basin outlet when positioned in the basin chamber, the collector defining one or more collector channel connecting a lower volume of the basin chamber to the collector chamber, the one or more collector channel having a collector channel outlet through which fluid flows into the collector chamber from the lower volume, the collector channel outlet being positioned above the collector bottom wall.

9. The device of claim 8, further comprising one or more valve operable to shift between a closed position in which the one or more valve blocks the one or more collector channel and an open position in which the one or more valve does not block the one or more collector channel.

10. The device of claim 9, wherein the one or more valve includes one or more biasing element configured to bias the one or more valve in the closed position.

11. The device of claim 10, wherein the one or more valve is configured to shift to the open position when the collector is positioned in the basin chamber.

12. The device of claim 11, wherein the one or more valve includes a cartridge rod slidably connected to the collector and comprising a stem extending into the one or more collector channel and a valve gasket connected to the stem and operable to block the one or more collector channel when the one or more valve is in the closed position.

13. The device of claim 12, wherein a bottom end of the cartridge rod is configured to abut a portion of the basin when the collector is positioned in the basin chamber to shift the one or more valve to the open position.

14. The device of claim 8, wherein the basin has one or more detent, and the collector has one or more catch configured to releasably couple to the one or more detent.

15. The device of claim 8, further comprising a basket connected to the collector, the basket comprising a base wall at least partially covering the collector chamber and one or more basket side wall extending from the base wall and defining one or more basket aperture through which fluid can flow from inside the basket into the lower volume of the basin chamber.

16. The device of claim 15, wherein the basket includes one or more spout protrusion extending from the base wall above the one or more basket side wall and including one or more spout hole in fluid communication with the collector chamber.

17. The device of claim 16, wherein the one or more spout protrusion includes two opposing walls with grip structures.

18. The device of claim 16, further comprising a cartridge outlet tube at least partially defining one or more flow path from the lower volume to the basin outlet.

19. The device of claim 18, wherein the one or more flow path is s-shaped.

20. The device of claim 15, wherein the basket is removably connected to the collector.

21. A method of installing a sink filtration device to a drain hole of a sink and to a drainpipe, the method comprising:
positioning a basin gasket on a top surface of the sink around the drain hole;
inserting a basin into the drain hole so that a basin flange of the basin is positioned on the basin gasket, the basin having one or more basin side wall and a basin bottom wall that together at least partially define a basin chamber;
positioning an insert gasket on a top surface of the basin bottom wall around a basin outlet defined by the basin bottom wall;
inserting a tubular threaded insert through the basin outlet so that an insert flange of the tubular threaded insert is positioned on the insert gasket;
positioning a basin sleeve against a bottom surface of the sink around the drain hole so that a sleeve gasket seated on a sleeve flange of the basin sleeve contacts the bottom surface of the sink and so that the basin sleeve receives the basin and a sleeve aperture at a bottom end of the basin sleeve receives at least a portion of the tubular threaded insert;
fastening a basin nut to the tubular threaded insert so that the basin nut applies a downward force on the basin via the insert flange and an upward force on a bottom surface of the basin sleeve, thereby clamping the basin and the basin sleeve to the sink; and
inserting a cartridge assembly through the drain hole so that the cartridge assembly is removably positioned inside the basin to define with the one or more basin side wall an outer volume of the basin chamber, the cartridge assembly comprising:
a cartridge outlet tube having a lower end extending into a portion of the tubular threaded insert when the cartridge assembly is in the basin, the lower end defining a tube outlet in fluid communication with the tubular threaded insert, and an upper end defining a tube inlet,
an outlet housing at least partially defining a housing channel connecting the outer volume to the tube inlet when the cartridge assembly is positioned in the basin, the housing channel having a housing channel inlet positioned below the tube inlet, and
a collector defining a collector chamber and having a collector bottom wall positioned above the housing channel inlet, the collector at least partially defining one or more collector channel connecting the outer volume to the collector chamber when the cartridge assembly is positioned in the basin, the one or more collector channel having a collector channel outlet through which fluid flows into the collector chamber from the outer volume when the cartridge assembly is positioned in the basin, the collector channel outlet being located above the collector bottom wall.

22. The method of claim 21, wherein the cartridge assembly is assembled prior to inserting the cartridge assembly into the basin.

23. The method of claim 21, further comprising fluidly connecting the tubular threaded insert to the drainpipe.

24. A device for coupling to a drain hole of a sink and to a drainpipe, the device comprising:
a basin assembly for coupling to the sink at the drain hole, the basin assembly comprising:
one or more basin side wall defining a basin inlet for receiving fluid flowing from the drain hole, and
a basin bottom wall connected to the one or more basin side wall to at least partially define a basin chamber, the basin bottom wall further defining a basin outlet through which fluid can flow to the drainpipe; and
a cartridge assembly sized to fit through the drain hole and removably coupled with the basin assembly inside the basin chamber to define an outer volume of the basin chamber with the one or more basin side wall, the cartridge assembly comprising:
a cartridge outlet tube having a lower end extending into the basin outlet and defining a tube outlet in fluid communication with the basin outlet, and an upper end defining a tube inlet at a first distance relative to the basin bottom wall when the cartridge assembly is positioned in the basin chamber,
an outlet housing defining a housing channel connecting the outer volume to the tube inlet, the housing channel having a housing channel inlet at a second distance relative to the basin bottom wall when the cartridge assembly is positioned in the basin chamber, the second distance being shorter than the first distance, and
a collector defining a collector chamber in the basin chamber and having a collector bottom wall at a third distance relative to the basin bottom wall when the cartridge assembly is positioned in the basin chamber, the third distance is longer than the second distance, the collector defines one or more collector channel connecting the outer volume to the collector chamber, the one or more collector channel having a collector channel outlet through which fluid flows into the collector chamber from the outer volume, the collector channel outlet being located at a fourth distance relative to the basin bottom wall when the cartridge assembly is positioned in the basin chamber, the fourth distance being longer than the third distance.
